(19) United States
(12) Patent Application Publication
(10) Pub. No.: US 2004/0229630 A1
(43) Pub. Date: Nov. 18, 2004

(54) Controlling loads in the uplink direction for wireless communications systems with power control

(75) Inventors: Francois Baccelli, Meudon (FR); Bartlomiej Blaszczyszyn, Bagneux (FR); Mohamed Kadhem Karray, Issy Les Moulineaux (FR)

Correspondence Address: FOLEY AND LARDNER, SUITE 500, 3000 K STREET NW, WASHINGTON, DC, 20007, US

(73) Assignees: FRANCE TELECOM; INRIA INSTITUT NATIONAL DE RECHERCHE EN INFORMATIQUE ET EN AUTOMATIQUE

(21) Appl. No.: 10/825,630

(22) Filed: Apr. 16, 2004

(30) Foreign Application Priority Data
Apr. 30, 2003 (FR) 0305355

(51) Int. Cl. H04Q 7/20

(52) U.S. Cl. 455/453; 455/423; 455/424

(57) ABSTRACT

Control device for a wireless communications network, comprising a calculator of quantities related to attenuations measured between mobiles and base stations, and/or to the signal to interference and noise ratio threshold, and a decision device with regard to the processing of new candidate mobiles, this device operating conjointly with the calculator according to a predefined mechanism. The said mechanism comprises: a load calculation function for each mobile, and an evaluation of a working condition, representing the feasibility of the servicing of mobiles by a station.

### BACKGROUND OF THE INVENTION

The invention concerns wireless cellular communications systems with power control, such as UMTS (standing for “Universal Mobile Terrestrial System”).

A cellular communications system is based on base stations capable of serving “mobile” user stations. Each mobile requires a certain service, which is composed of data to be transmitted under certain conditions (transmission rate, time, etc). A mobile which is receiving such a service is said to be an “active mobile”.

What is referred to as load control is a technique for controlling the traffic in terms of incoming mobiles (admission control) and traffic in terms of current mobiles (congestion control). Load control can therefore include the following functions:

admission control determines whether the system is accepting a new mobile or not,

congestion control examines what is happening for the active mobiles, according to the services which they are requesting.

Load control tends in particular to guarantee the quality of service (QoS) for mobiles in real time and for non-real time mobiles (elastic transmission rate). Providing effective load control is crucial in wireless systems with power control.

The known load control techniques do not give full satisfaction, as will be seen in detail below. The main reasons for this relate to efficiency, speed and ability to process a large number of mobiles.

### SUMMARY OF THE INVENTION

The present invention aims to improve the situation.

The invention concerns a control device for a wireless communication network, comprising a calculator for quantities related to attenuation measured between mobiles and base stations, and/or the threshold of the ratio of signal to interference and noise, and a decision device with regard to the processing of new candidate mobiles, this device operated conjointly with the calculator according to a predefined mechanism.

According to a principal feature of the invention, the mechanism comprises:

a load calculation function, for each mobile, and

an evaluation of a working condition, representing the feasibility of the servicing of mobiles by a station.

According to one advantageous aspect of the invention, the working condition relates to the summed load due to the mobiles served by a station in question. In addition, the load calculation function comprises, for a mobile, the summing of the inverses of the attenuations of the adjacent stations, the result being multiplied by an expression related to the signal to interference and noise ratio threshold, and by the attenuation at the server station.

Preferably, the device comprises storage of a current value of the summed load, and the mechanism operates incrementally by calculating the load of a candidate mobile and updating the summed load in order to determine whether or not the mobile is accepted by comparing the summed load with a threshold.

Advantageously, the calculator is provided with a function capable of evaluating a prior uplink budget condition compared with a budget threshold value. In addition, the mechanism used by the decision device first of all invokes the said prior condition budget function and rejects the candidate mobile if this condition is not satisfied.

According to an embodiment by way of example, the prior condition comprises, for a mobile, the calculation of its maximum power, divided by an expression related to the signal to interference and noise ratio threshold and by the attenuation at the server station.

According to a particular embodiment of the invention, the working condition comprises a threshold value established in correspondence with the said budget threshold value.

The device according to the invention advantageously comprises a second mechanism capable of cooperating with the calculator in order to evaluate, for a given station, a non-congestion criterion, and a second decision device, capable of modifying the mobile transmission rates in order to remain within the field of the congestion criterion.

In a first embodiment, the second mechanism comprises, for each mobile, the calculation of its signal to interference and noise ratio threshold, and then the calculation of an expression related to this signal to interference and noise ratio threshold, and next the invocation of the load calculation function with these values, and then the calculation of the summed load due to the mobiles served by a station in question, this summed load being compared with a threshold.

In a second embodiment, the second mechanism comprises, for each mobile, the calculation of its signal to interference and noise ratio threshold, and then the calculation of an expression related to this signal to interference and noise ratio threshold, and next:

the invocation of the function capable of evaluating the prior uplink budget condition, with respect to a budget threshold value, the mobile concerned being rejected if this prior condition is not satisfied,

for the mobiles which are not rejected, the invocation of the load calculation function with the aforementioned values, and then the calculation of the summed load due to the mobiles served by a station in question, this summed load being compared with a threshold related to the budget threshold.

The invention also concerns a control method for a wireless communication network comprising the steps consisting of

a. calculating a load for each mobile from the quantities related to attenuations measured between mobiles and base stations, and/or the threshold of the signal to interference and noise ratio,

b. from the loads calculated at step a, evaluating a working condition, representing the feasibility of the servicing of mobiles by a station,

c. deciding on the treatment of new candidate mobiles from step b.

According to one advantageous aspect of the invention, the working condition of step b relates to the summed load due to the mobiles served by a station in question.

In addition, step a comprises, for a mobile,

summing the inverses of the attenuations of the adjoining stations,

multiplying the result by an expression related to the signal to inference and noise ratio threshold, and by the attenuation at the server station.

Preferably, step b comprises storing a current value of the summed load and, during a new iteration of the method for a candidate mobile, step a comprises calculating the load of the candidate mobile, step b comprises updating the summed load and comparing the summed load with a threshold in order to determine whether or not the mobile is accepted at step c.

Advantageously, step a comprises first of all evaluating a prior uplink budget condition, with respect to a budget threshold value, and rejecting the candidate mobile if this condition is not satisfied.

According to an embodiment by way of example, the prior condition of step a comprises, for a mobile, the calculation of its maximum power, divided by an expression related to the signal to interference and noise ratio, and by the attenuation at the server station.

According to an embodiment by way of example, the working condition of step b comprises a threshold value, established in correspondence with the said budget threshold value.

According to a particular embodiment of the invention, steps a and c comprise evaluating, for a given station, a non-congestion criterion, and step c comprises modifying the mobile transmission rates in order to remain within the field of the congestion criterion.

Preferably, step a comprises, for each mobile, calculating its signal to interference and noise ratio threshold and then calculating an expression related to this signal to interference and noise ratio threshold, and calculating the load of each mobile with this expression, and step b comprises calculating the summed load due to the mobiles served by a station in question and comparing this summed load with a threshold.

In a variant, step a comprises, for each mobile, calculating its signal to interference and noise ratio threshold and then calculating an expression related to this signal to interference and noise ratio threshold, and next:

evaluating the prior uplink budget condition, with respect to a threshold budget value, the mobile concerned being rejected if this prior condition is not satisfied,

for the mobiles which are not rejected, calculating the loads from the calculated expressions, the summed load due to the mobiles served by a station in question being calculated and compared with a threshold relating to the threshold budget at step b.

### BRIEF DESCRIPTION OF THE DRAWINGS

Other features and advantages of the invention will emerge from an examination of the following detailed description, and the accompanying drawings, in which:

FIG. 1 illustrates schematically a cellular communications network,

FIG. 1A illustrates schematically in more detail a cellular communications network,

FIG. 2 illustrates in the form of a flow diagram a first example of a mechanism implementing the invention,

FIG. 2A illustrates a computer structure able to implement the first mechanism,

FIG. 3 illustrates, in the form of a flow diagram, a second example of a mechanism implementing the invention,

FIG. 4 illustrates, in the form of a flow diagram, the decentralised aspect of the mechanisms implementing the invention,

FIG. 5 illustrates, in flow diagram form, a variant of the first example of a mechanism implementing the invention,

FIG. 6 illustrates, in flow diagram form, a variant of the second example of a mechanism implementing the invention,

FIG. 7 illustrates, in flow diagram form, a third example of a mechanism implementing the invention, and

FIG. 8 illustrates, in flow diagram form, a fourth example of a mechanism implementing the invention.

### DESCRIPTION OF THE PREFERRED EMBODIMENTS

The present description also comprises an annexe 1, in which there are grouped together the formulae, preceded by a definition of the notations which they use, which can be utilised in the present description.

The drawings and annexes of the description can not only serve to supplement the invention but also contribute to its definition, where necessary.

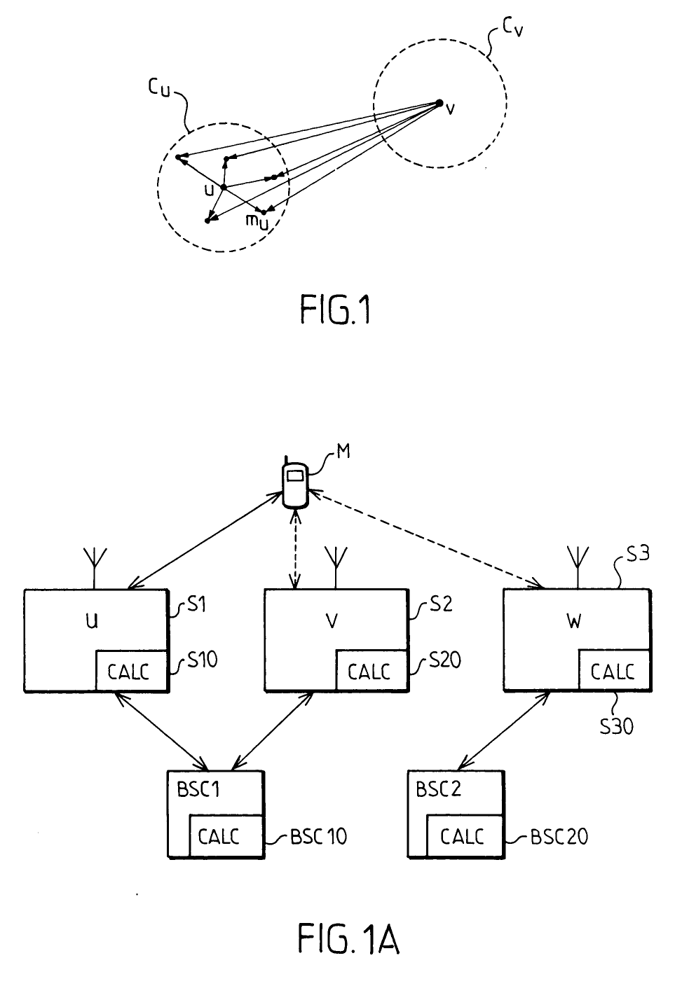

FIG. 1 illustrates an example of a cellular network with two stations denoted u and v.

Each station u, v serves the mobiles located in a certain geographical area, referred to as a cell, Cu, Cv. Five mobiles are illustrated here, designated generically by mᵤ, in the cell Cu of the station u. In practice, there exist other mobiles mᵥ, not shown, in the cell Cv of the station v.

To simplify, FIG. 1 illustrates cells by means of discs but they can have any other shape. The cells may have a certain intersection, referred to as a “handover” area.

In the present description:

a “base station”, which can be abbreviated to “station” or “antenna”, comprises a network antenna, directional or omnidirectional, and the electronic assembly associated with it;

the expressions “user station” or “user equipment” or “mobile” or even “user” designate any equipment capable of wireless communication, and possibly able to move;

the expression “uplink direction” refers to the case where a mobile is seeking to establish or maintain communications with the station; the expression “downlink direction” relates to the case where the base station is seeking to establish or maintain communications to the mobile;

a “service” is what a mobile requires, essentially in given terms, to transmit under certain conditions (transmission rate, time in particular);

an “active” mobile is a mobile which is receiving such a service;

a “non-real time” (or NRT) service can accommodate to a fairly variable or “elastic” rate;

a “real-time” (or RT) service cannot accommodate to an elastic rate; it requires a substantially predefined rate, or at least a predefined minimum rate;

the expression “with power limitation” refers to the case where the transmission powers of the mobiles and station must remain less than or equal to a threshold. Actual systems such as UMTS have in principle a power limitation;

the expression “without power limitation” refers to the case where the transmission powers of the mobiles and station would have no maximum threshold constraint to comply with.

At any time, a given mobile has a geographical position which is peculiar to it; it requires a certain service; it could be served by one or more stations; if it is active, it is effectively served by a certain station. Thus:

a given set of stations and mobiles is referred to as a “configuration of mobiles” (and, implicitly, of stations, these remaining fixed).

Load control in the cellular networks with power control aims to ensure that, for the configurations of mobiles encountered, there exists an allocation of power complying with certain requirements in terms of signal to interference and noise ratio (SINR) and, where applicable, power limitations.

Here the expression “PAP criterion” or the acronym “PAP” alone (derived from “Power Allocation Principle”) designates a criterion used for determining the feasibility of the allocation of power, in the presence of a given configuration of mobiles. In particular two different criteria denoted UPAP and EUPAP will be described. The notation xPAP designates either of such criteria.

The French patent application No 03 02017, filed on 19 Feb. 2003, describes in depth the context of load control in a wireless communications network, affording new solutions for it. Its descriptive content is considered to be incorporated by reference in the present description, to which it can where necessary be annexed, with its own drawings and annexes.

Although some of its aspects may also apply to the downlink direction (in particular as described in another patent application filed on the same date) the present description refers principally to the uplink direction.

FIG. 1 also illustrates an example of the configuration of mobiles served by the station u (mᵤ indicates a mobile served by the station u). The figure illustrates the paths of the mobiles to their server station u on the one hand and to the other stations (such as v) on the other hand. The propagation losses along these paths are referred to as attenuations. A station is said to be adjacent to a mobile if the mobile can measure the attenuation at this station.

FIG. 1A shows three base stations S1, S2 and S3, each provided with an antenna and, in particular, a calculation module (S10, S20, S30). The normal wireless telecommunications circuits are not shown, for the sake of simplicity. A mobile M is within range of three stations; it is assumed to be active with the station S1. In the example, the stations S1 and S2 are under the control of a base station controller BSC1; another base station controller BSC2 takes care of the station S3, and one or more other stations, not shown. The controllers also have calculation capacities BSC10 and BSC20, and their other normal functions, not shown. The three stations have for example the ranges defined by the cells in FIG. 1.

An increase in the number of mobiles may result in a situation where the allocation of powers does not admit of a solution (it is then said that the allocation of powers is not feasible). In such a case, it is said that the system is in a congestion situation.

The aim of load control is to prevent this from occurring. Several load control methods or algorithms have been proposed in the literature.

The so-called “direct” algorithms are based on a “load indicator”, which is chosen so as to be calculable, and to represent the magnitude of the load on the system. The load indicator most generally used for the uplink direction is derived from the total interference (the sum of the noise and the powers of all the mobiles) received at the station. This has been proposed by

[1] A. J. Viterbi, “CDMA: Principles of Spread Spectrum Communications”, 1995.

Other indicators have also been proposed, comprising in particular the SINR (“Signal to Interference and Noise Ratio”), and/or bit rate quantities D_{bit}, or equivalent.

Load control is then based on a comparison of this load indicator with a threshold value, referred to as the load threshold, for the uplink direction. A new mobile can be accepted only if it can be served without causing the load indicator to pass beyond the threshold in the uplink direction.

These direct algorithms have the following drawbacks:

the load indicators used by these algorithms depend on the powers of the mobiles, which fluctuate over time (for example according to their movements). This obliges the operator to adopt a wide safety margin for the load threshold. Moreover, the additional load caused by a new call must be estimated approximately;

in addition, the known direct algorithms do not ensure that an allocation of power exists. Consequently, in actual systems, communication cuts may occur, including immediately after the acceptance of a new mobile;

moreover, direct algorithms perform iterations in order to attempt to resolve the problem of power control several times, before obtaining a feasible solution (the term feasible means that there is a solution). This method may result in eliminating more mobiles than is necessary. In addition, direct algorithms are very slow when they must deal, starting from nothing, with a given configuration of base stations and mobiles (for example in a simulation tool).

In another type of algorithm, referred to as the “test” type, a new mobile is admitted temporarily before a decision is taken. This is described in:

[2] Zvi Rosberg, Michael Andersin and Jens Zander, “Soft and Safe Admission Control in Cellular Networks”, IEEE Transaction on Network 5(2):414-418, April 1997.

[3] N. Bambos, S. C. Chen and G. J. Pottie, “Channel Access Algorithms with Active Link Protection for Wireless Communication Networks with Power Control”, IEEE/ACM Transactions in Networking 8(5):583-596, October 2000.

The “test” algorithms have the advantage of being secure, in that no cut-off will occur, at least until the time of the decision. On the other hand, their execution requires so much time that they cannot be used in practice, particularly in real systems.

An admission control algorithm has also been proposed for the uplink direction based on the concept of effective band, inspired by the ISDN (Integrated Service Digital Network) broadband network, using ATM (Asynchronous Transfer Mode):

[4] J. S. Evans and D. Everitt, “Effective Bandwidth-Based Admission Control for Multiservice CDMA Cellular Networks”, IEEE Transactions on Vehicular Technology 48, January 1999.

This admission control algorithm based on the effective band concerns only the uplink direction; it takes account neither of power limitations nor noise; finally, it is centralised, that is to say it is not possible to process each station independently of the others.

The present invention aims to deal with the control of admission and congestion in a novel manner, for the uplink direction, that is to say from a mobile to a station.

The present invention has several aspects, which can be taken independently.

Global PAP criterion will be spoken of when this criterion must be applied to a set of stations in the network, and decentralised PAP criterion when this criterion can be applied to a single base station.

The invention proposes first of all a decentralised PAP criterion for the uplink direction, denoted UPAP (from “Uplink Power Allocation Principle”). This criterion can be used as a condition for the feasibility of power control in the uplink direction, without consideration of power limitation.

To take account of the power limitation, the invention proposes a criterion denoted EUPAP (extended decentralised power allocation principle for the uplink direction, that is to say “Extended Uplink Power Allocation Principle”).

The invention also proposes decentralised mechanisms or algorithms for admission and congestion control based on UPAP and EUPAP.

First of all the uplink direction is examined in “without power limitation” mode.

It can be considered that the power control in the uplink direction without power limitation is feasible if, for all the mobiles mᵤ, powers exist which are not all negative Pₘᵤ which satisfy the condition A.1. This condition expresses the fact that, for each mobile, the signal to interference and noise ratio (SINR) is above a given threshold, peculiar to this mobile.

The decentralised power allocation criterion for the uplink direction (UPAP) can then be considered. Its expression by the annexed condition A.2 uses the modified SINR, also defined in the annexe. The meaning is as follows:

If, for each station u, the condition A.2 is satisfied, then power control in the uplink direction without power limitation is feasible. The coefficient k in equation A.2 represents a safety margin which fixes the threshold below 1.

The case of the uplink direction in “with power limitation” mode is now examined.

It can be considered that power control in the uplink direction with power limitation is feasible if non-negative powers Pₘᵤ exist for all the mobiles mᵤ, for which, at the same time:

condition A1 is satisfied, and

the power emitted for each mobile does not exceed the given limit, as expressed in equation A.3. This limit corresponds to the maximum power of the mobile able to take account of the gain and the antenna loss.

The EUPAP criterion can then be expressed. A constant θ between 0 inclusive and 1 exclusive is fixed, referred to as the UBC threshold, standing for Uplink Budget Condition, in brief “budget threshold”.

If the two conditions A.4 and A.5 are satisfied then, with a high probability, power control in the uplink direction with power limitation is feasible.

These novel load control methods have the following advantages:

1. The processing is decentralised, in that it relates on each occasion to a population of the mobiles served by a station, individually.

2. The load indicators used depend only on the attenuations between the mobiles and the stations, the SINR thresholds and the power limits.

3. These indicators do not depend on the transmission powers, and consequently they do not fluctuate because of iterations performed during the calculation of these powers.

4. The additional load induced by a new mobile can be calculated with precision.

5. The novel load control algorithms have the advantages of the direct and “test” algorithms and avoid their drawbacks. They are simultaneously rapid and secure.

A person skilled in the art already knows how to measure the attenuations between a mobile and several stations. Considering for example the UMTS system, the standard provides for measuring the attenuations between a mobile and 32 stations. Thus the parameters required for constructing an xPAP criterion are available.

The invention can be applied in simulation in a computer of suitable capacity.

The invention can be applied in true systems by providing a control device at least partially implementing the proposed algorithms. This control device can be located at the computer of a base station (referred to as Node B in UMTS) and/or at the computer situated in the base station controller (referred to as RNC in UMTS). It can also for example be distributed between these two elements.

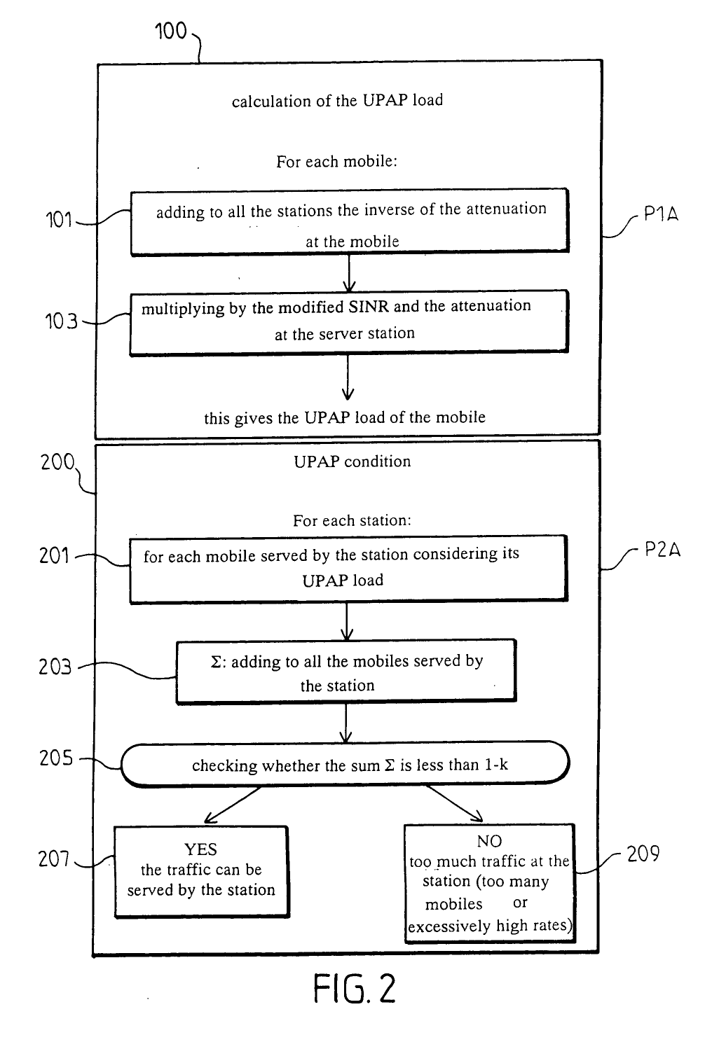

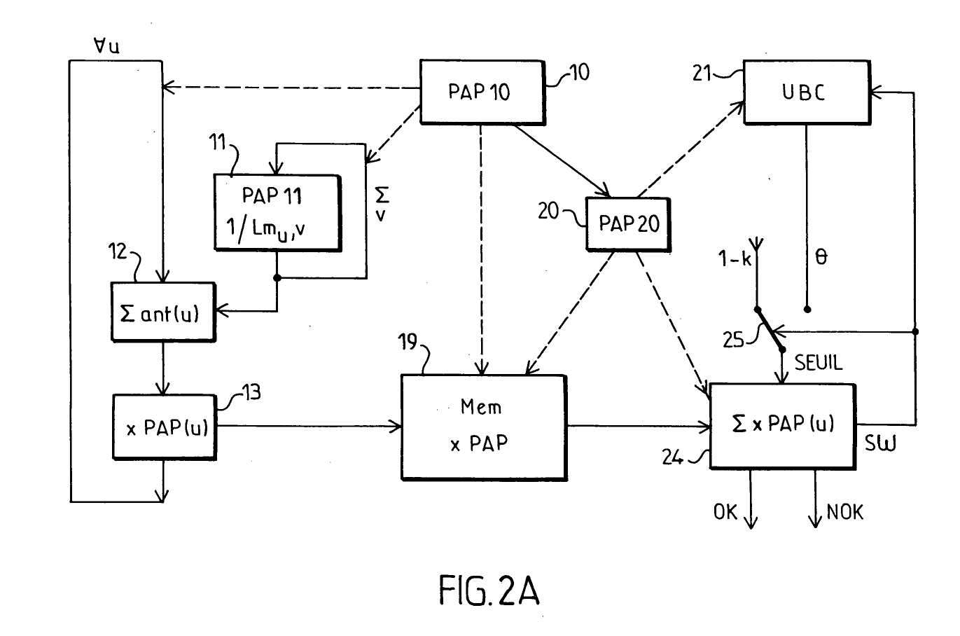

In FIG. 2, the unit 100 or P1A provides the calculation of the load xPAP, here UPAP, for each mobile. The unit 200 or P2A provides the summing of the loads of the mobiles individually served by a given station (u), for the purpose of determining the feasibility condition xPAP, here UPAP.

The unit 100 here performs two operations:

an operation 101, which consists of adding to all the stations the inverse of the attenuation at the mobile L_{mu,v}

an operation 103, which consists of multiplying the result of the operation 101 by the modified SINR, as well as the attenuation at the server station L_{mu,u} (in the index, “mu” corresponds to “mᵤ” in the accompanying formulae). The result is the load UPAP of the mobile (user equipment).

It will be understood that this unit P1A performs all the operations of the first member of the annexed equation A.2, with the exception of the summing which appears at the head of this equation A.2.

This head summing is performed in the unit 200 or P2A, which performs the following operations:

at 201, for each mobile served by the station in question, access is gained to its load UPAP, if necessary suitably stored in memory in the meantime,

step 203 then consists of summing this load UPAP for all the mobiles served by this station u in question. The sum thus obtained is denoted in abbreviation Σ,

step 205 checks whether the sum obtained Σ is below a threshold.

In the calculation mode given by way of example, the loads xPAP (and others) have no dimension. It is possible therefore to fix the threshold at 1, or at 1-k, where k is a suitably chosen safety margin, as indicated in equation A.2.

If the sum Σ is below the threshold 1-k, the operation 207 indicates that the traffic can be served by the station u in question. In the contrary case, the operation 209 indicates that there is too much traffic at the station: for example, either it is serving too many mobiles or the mobiles, or some of them, are served at excessively high rates.

The UPAP process presented in FIG. 2 is an example of an implementation of the invention for ensuring the feasibility of power allocation in the uplink direction without power limitation.

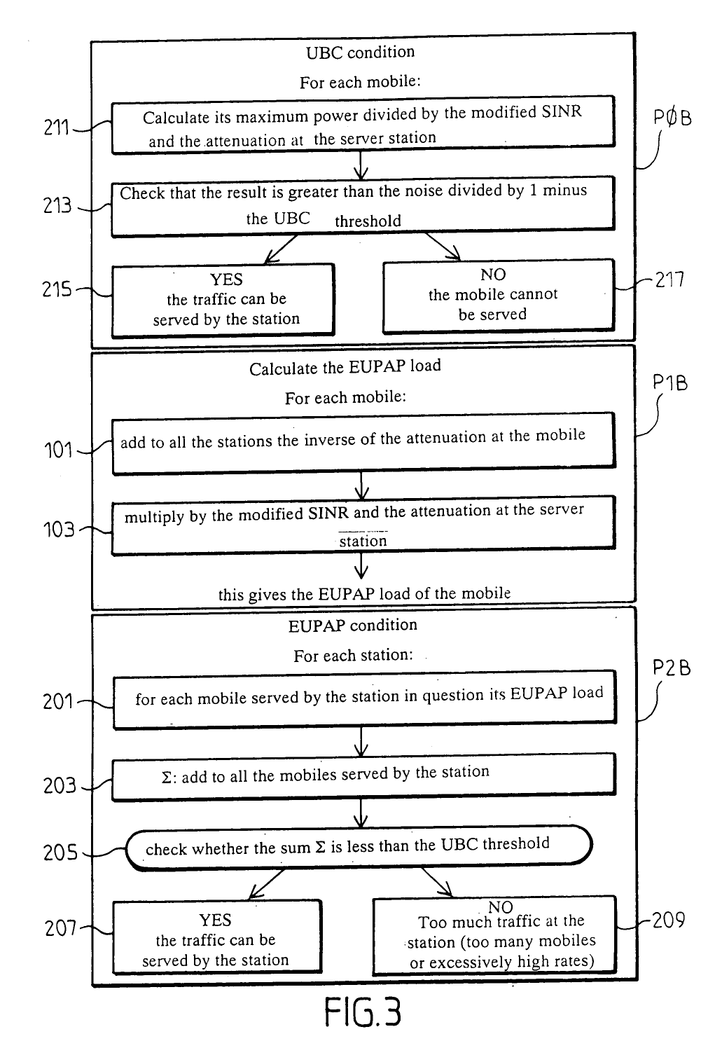

FIG. 2A is a view by concrete modules of the mechanism illustrated in FIG. 2. It will be seen that it shows the similarities with the process in FIG. 3.

The calculation module PAP11 is capable of performing the inverse calculation provided at operation 101, for a station v.

As indicated by the loop appearing in FIG. 2A, this is repeated for all the stations v considered for the mobile concerned. The sum which results therefrom is stored in the unit 12.

This is controlled by a first calculation manager PAP 10. This provides control of the whole of the calculation performed in P1A (FIG. 2), as indicated by the arrows in broken lines in FIG. 2A.

Overall, this is repeated for all the mobiles, as indicated by the loop which operates between the unit 12 and the unit 13. The latter therefore sequentially supplies the various loads UPAP for the mobiles in question of the station u. The values thus obtained can be put in memory at 19.

The first calculation manager PAP10 then passes control to a second calculation manager PAP20, which can implement the mechanism P2A.

It does so, in the example, in cooperation with the memory 19, and with the cell PAP24. It performs the first two operations 201 and 203 in FIG. 2. This results in a sum ΣxPaP(u), which corresponds to a summing on all the users served by a given station u. The unit 24 makes a comparison of this sum with a threshold which it receives at an input 25. The aim is to determine whether the situation of operation 207 or 209 in FIG. 2 applies, that is to say whether the traffic can or cannot be served by the station u.

In the case of the mode without power limitation, or UPAP, the threshold is at a value equal to or slightly less than 1, that is to say 1-k, in accordance with equation A.2.

The case with power limitation is now considered. With regard to the unit 24 in FIG. 2A, this can result in:

the switching of the switch 25, which will now give a threshold E at the unit 24 (instead of 1-k), and

the implementation of a calculation function UBC, referenced 21 in FIG. 2A.

For reasons of clarity, the calculations which are now made are referred to as EUPAP. However, and this is one of the advantages of the invention, they are fundamentally similar to those which were described with reference to FIG. 2.

Thus the middle part P1B and the bottom part P2B of FIG. 3 are expressed by the same functions as those in FIG. 2, and moreover bear the same reference. The only difference is that the threshold acting at step 205 is now the threshold Θ, also referred to as threshold UBC, instead of the threshold 1-k in FIG. 2. In principle, the threshold e is less than the threshold 1-k. It can remain close to (1-k), by lower values, for a mobile close to the station; it decreases when the mobile moves away from the station. It is a case here not of geographical proximity but of electromagnetic proximity, having regard to any obstacles attenuating the propagation of the waves.

Prior to the performance of these operations P1B and P2B in FIG. 3, provision is made for calculating a “UBC condition”, the mechanism of which is illustrated at P0B in FIG. 3. This mechanism comprises, for each mobile:

operation 211, which consists of calculating the maximum power allowed for the mobile, divided by the modified SINR and the attenuation at the server station, and

test 213, which verifies that the result is greater than the noise N divided by 1-Θ, where Θ is the UBC threshold,

if the test is positive, the mobile can probably be served by the station, as indicated at 215; if on the other hand the test is negative, the mobile cannot in principle be served by the station, as indicated at 217.

In the case 215 where the test has been positive, the continuation provides the calculations illustrated in the middle part P1B and low part P2B of FIG. 3 be redone, but this time using the UBC threshold denoted Θ at operation 205.

The performance of these operations being in principle the same as for FIG. 2, it will not be described again.

At 207 or 209, a conclusion is finally reached that the traffic related to all the mobiles can or cannot be served by the station u in question.

The module P0B in FIG. 3 performs the calculations of equation A.4. The modules P1B and P2B perform the calculations of the equation A.5.

The EUPAP process presented in FIG. 3 constitutes an example of implementation of the invention in order to ensure, with high probability, the feasibility of the allocation of power in the uplink direction with power limitations.

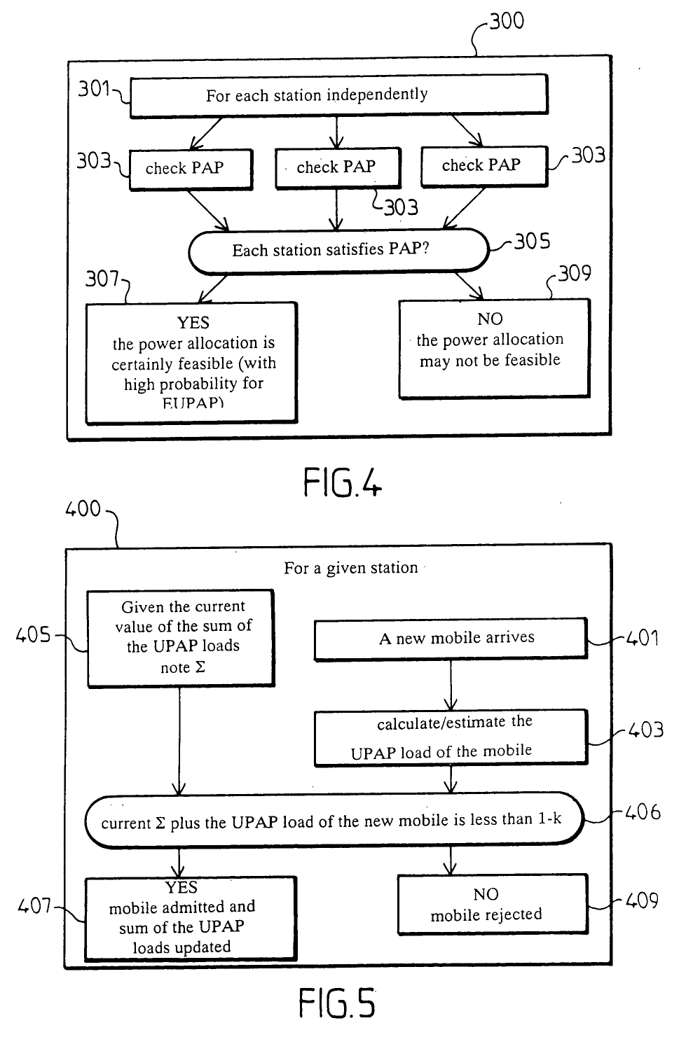

Reference will now be made to FIG. 4, which illustrates the fact that the mechanisms proposed according to the invention are “decentralised”.

In FIG. 4, the abbreviation PAP designates either the UPAP or EUPAP calculation (it corresponds to xPAP in FIG. 2A). For the various stations independently (301), PAP checks (303) will be carried out. If each station satisfies the PAP condition (305), then overall power allocation is certainly feasible (or feasible with a high probability if it is a case of EUPAP), as indicated at 307. In the contrary case, it may be that power allocation is not feasible, as indicated at 309.

In the above, the mechanisms proposed are implemented in an absolute manner, that is to say by once again performing all the calculations on each occasion, as if at all times there were a totally new mobile/station configuration.

Naturally, it is possible in practice to operate the same mechanisms in a relative manner. A description will now be given of the most simple example, with reference to a new mobile entering an actual configuration, already in service. In fact, it is a case of a new incoming mobile for a given station: either this new mobile is seeking a connection, or it is a mobile connected to another station, and for which a change in station is envisaged.

FIG. 5 illustrates an example of admission control in the uplink direction, without power limitation, that is to say of the UPAP type.

There exists in the memory 19 in FIG. 2A a current value of the sum of the current UPAP loads. (This assumes that UPAP mode currently applies; naturally, it would be a current value of the sum of the EUPAP loads if the mode with power limitation applied.)

When a new mobile arrives (401), the operation 403 consists of calculating or estimating the UPAP load of this mobile, using the calculation functions P1A in FIG. 2, or, which amounts to the same thing, the modules 11, as well as 12 and 13 in FIG. 2A (but only once for the modules 12 and 13, without making the loop on all the mobiles).

Operation 406 then consists of increasing the current value stored at 405 of the UPAP load of the new mobile, and testing whether the result remains below 1-k. If so, the mobile is admitted at 407, and the sum of the UPAP loads is updated in the memory 19. Otherwise the mobile is rejected at 409, by virtue of the mode without power limitation.

The operations in FIG. 5 may remain to be effected under the control of the manager 10 in FIG. 2A, which operates as previously, except that it inhibits the loop operating on the calculation functions 12 and 13, as already indicated.

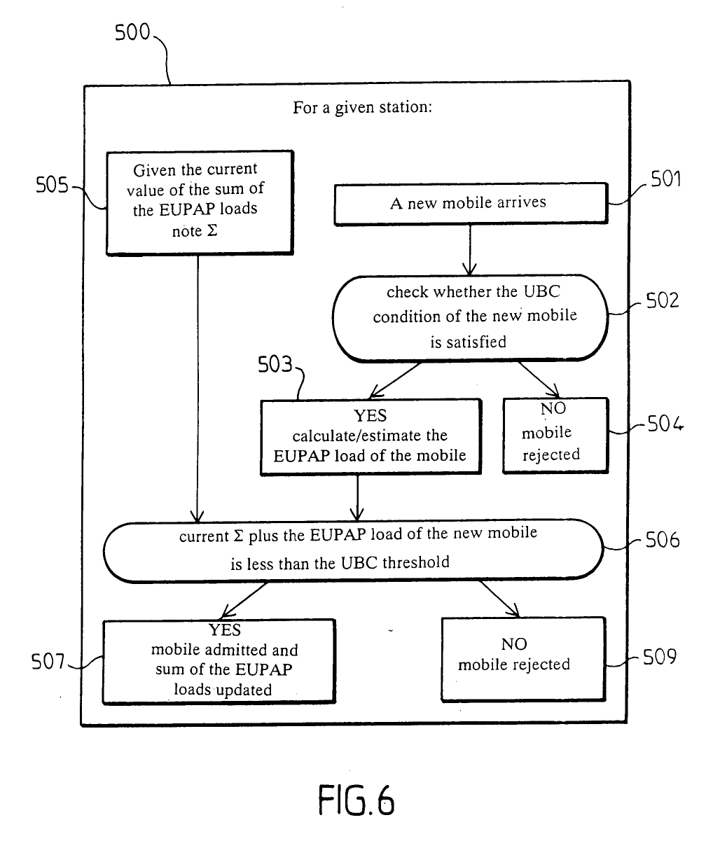

The case of admission control in the uplink direction with power limitation, that is to say based on EUPAP, is illustrated in FIG. 6.

The functioning is essentially the same as in FIG. 5. The elements which correspond to each other have numerical references increased by 100. However, before calculating or estimating at 503 the EUPAP load of the mobile, a check is made at 502 whether the UBC condition is satisfied for the new mobile. If it is not satisfied, this mobile is immediately rejected at 504. Otherwise operation 503 is passed on to, and it is only at the end, at 507 or 509, that the mobile will finally be admitted, or rejected.

The invention also, or separately (this aspect could be separate), makes it possible to control congestion in the uplink direction.

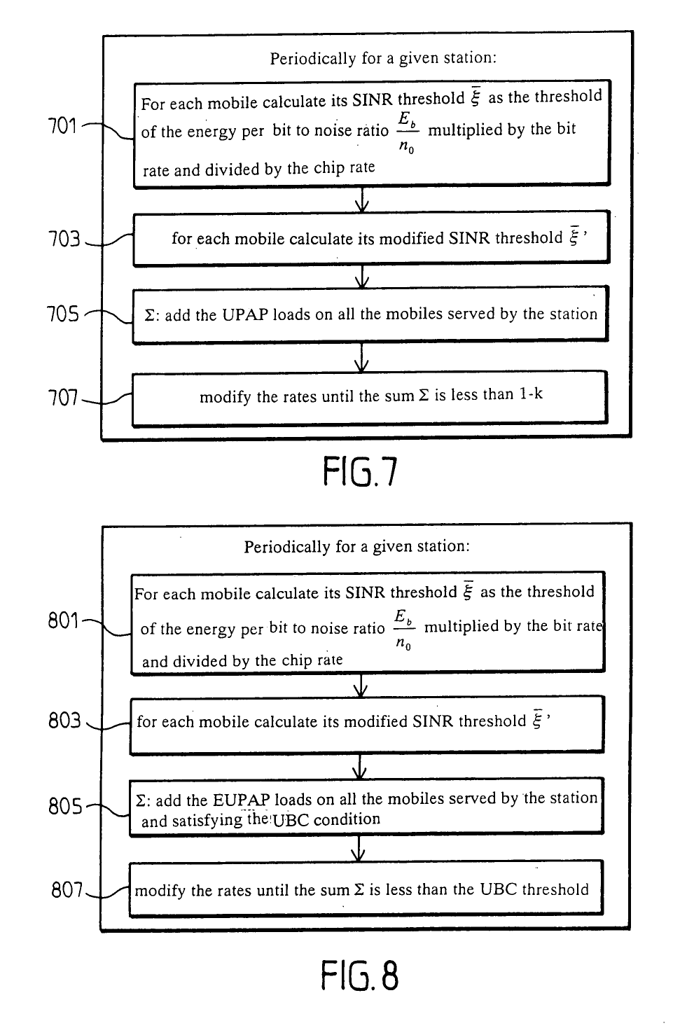

FIG. 7 illustrates a mechanism for controlling congestion in the uplink direction based on UPAP.

This mechanism is implemented periodically, for each station, one by one. It is implemented as follows:

operation 701 consists, for each mobile, of calculating its signal to interference and noise ratio threshold. This threshold is defined as the threshold of the ratio of energy per bit to noise Eb/n0, multiplied by the bit rate D_{bit}, and divided by the chip rate D_{chip}. The chip rate defines a rate related to the period of a carrier or subcarrier used for the spectral spread;

operation 703 consists, for each mobile of the station in question, of calculating the modified SINR threshold which is peculiar to it, in accordance with the notation appearing in the annexe;

next, operation 705 consists of adding the UPAP loads to all the mobiles served by the station. The UPAP loads are recalculated at each passage to operation 105, at least for those of the mobiles which have moved;

next, at step 707, the rates are reduced until the sum resulting from operation 705 is below 1-k, where k is a safety margin with respect to 1.

This safety margin k can be considered to be related to the mobility of the users. The lower the mobility of the users, the lower this margin. It is zero if all the users are fixed. It can be fixed in advance, for example according to an estimation, or statistics on this mobility, or be determined dynamically, from time to time.

FIG. 8 illustrates an algorithm for controlling congestion in the uplink direction, but this time with power limitation, that is to say based on EUPAP.

The operations there too are the same as those in FIG. 7 (the numerical references are increased by 100). The only essential difference is that, at steps 805 and 807, instead of taking the threshold 1-k, the UBC threshold denoted Θ is taken, as has already been seen with regard to FIG. 3.

Naturally the present invention is not limited to the embodiment described, in particular in detail, and extends to any variant implementing the principles disclosed.

In particular, a way of implementing the invention dynamically has been disclosed, using values already calculated. Other “incremental” operating modes can be envisaged.

It is also evident, from a reading of the description, that the processes of the invention, as well as the devices adapted for their implementation, are independent of each other and can be the subject of independent implementation.

Thus the decentralised power allocation process for the uplink direction can be based on UPAP or on EUPAP depending on whether or not this allocation is without power limitation. The same applies to the independent processes of the invention such as

the mobile admission processes, and

the congestion control processes,

based on UPAP or on EUPAP depending on whether or not this allocation is without power limitation.

1 Annexe 1

1.1 Notations

u, v stations

mᵤ a mobile served by a station u

L_{m,v} attenuation between the mobile m and the station v

N external noise

\overline{ξ}ₘ_{ᵤ} signal to interference and noise ratio (SINR) threshold for the mobile

$${m}_{u}$$

$${\overline{ξ}}_{{m}_{u}}^{′} = {\overline{ξ}}_{{m}_{u}} / ( 1 + {\overline{ξ}}_{{m}_{u}} )$$

modified SINR

Pₘ_{ᵥ} power emitted by the mobile mᵥ

\overline{P}ₘ_{ᵤ} maximum power of the mobile mᵤ

k safety margin with respect to 1.

1.2 Equations

$$\begin{matrix}\frac{{P}_{{m}_{u}} / {L}_{{m}_{u , v}}}{N + {Σ}_{v} {Σ}_{{m}_{v} \neq {m}_{u}} {P}_{{m}_{v}} / {L}_{{m}_{v} , u}} \geq {\overline{ξ}}_{{m}_{u}} , ∀ u , {m}_{u} & ( A .1 ) \\ {Σ}_{{m}_{u}} ( {Σ}_{v} 1 / {L}_{{m}_{u} , v} ) {\overline{ξ}}_{{m}_{u}}^{′} {L}_{{m}_{u} , u} < 1 - k & ( A .2 \text{-} UPAP ) \\ {P}_{{m}_{u}} \leq {\overline{P}}_{{m}_{u}} , ∀ u , {m}_{u} & ( A .3 ) \\ \frac{{\overline{P}}_{{m}_{u}}}{{\overline{ξ}}_{{m}_{u}}^{′} {L}_{{m}_{u} , u}} \geq \frac{N}{1 - \tilde{θ}} , ∀ u , {m}_{u} & ( A .4 \text{-} UBC ) \\ {Σ}_{{m}_{u}} ( {Σ}_{v} 1 / {L}_{{m}_{u} , v} ) {L}_{{m}_{u} , u} {\overline{ξ}}_{{m}_{u}}^{′} \leq \tilde{θ} , ∀ u & ( A .5 \text{-} EUPAP )\end{matrix}$$

What is claimed is:

1. Control device for a wireless communications network,
comprising a calculator of quantities related to attenuations measured between mobiles and base stations, and/or to the signal to interference and noise ratio threshold,
and a decision device with regard to the processing of new candidate mobiles, this device operating conjointly with the calculator according to a predefined mechanism,
characterised in that the said mechanism comprises:
a load calculation function for each mobile, and
an evaluation of a working condition, representing the feasibility of the servicing of mobiles by a station.

2. Device according to claim 1, characterised in that the working condition relates to the summed load due to the mobiles served by a station in question.

3. Device according to claim 1, characterised in that the load calculation function comprises, for a mobile, the summing of the inverses of the attenuations of the adjacent stations, the result being multiplied by an expression related to the threshold of the signal to interference and noise ratio, and by the attenuation at the server station.

4. Device according to claim 1, characterised in that it comprises storage of a current value of the summed load, and in that the said mechanism operates incrementally by calculating the load of a candidate mobile, and updating the summed load, in order to determine whether the mobile is admitted or not, by comparing the summed load with a threshold.

5. Device according to claim 1, characterised in that the calculator is provided with a function capable of evaluating a prior uplink budget condition (UBC), compared with a threshold budget value (UBC),
and in that the mechanism used by the decision device first of all invokes the said function of evaluation of the prior condition, and rejects the candidate mobile if this condition is not satisfied.

6. Device according to claim 5, characterised in that the prior condition comprises, for a mobile, the calculation of its maximum power, divided by an expression related to the threshold of the signal to interference and noise ratio, and by the attenuation at the server station.

7. Device according to claim 5, characterised in that the working condition comprises a threshold value, established in correspondence with the said threshold budget value (UBC).

8. Device according to claim 1, characterised in that it comprises a second mechanism capable of cooperating with the calculator in order to evaluate, for a given station, a non-congestion criterion, and a second decision device, capable of modifying the mobile rates in order to remain within the field of the congestion criterion.

9. Device according to claim 8, characterised in that the second mechanism comprises, for each mobile, the calculation of its signal to interference and noise ratio threshold, and then the calculation of an expression related to this signal to interference and noise ratio threshold, and next the invocation of the load calculation function with these values, and then the calculation of the summed load due to the mobiles served by the station in question, this summed load being compared with a threshold.

10. Device according to claim 8, taken in combination with claim 5, characterised in that the second mechanism comprises, for each mobile, a calculation of its signal to interference and noise ratio threshold, and then the calculation of an expression related to this signal to interference and noise threshold, and next:
the invocation of the function capable of evaluating the prior uplink budget condition (UBC), compared with a threshold budget value (UBC), the mobile concerned being rejected if this prior condition is not satisfied,
for the mobiles not rejected, the invocation of the load calculation function with the aforementioned values, and then the calculation of the summed load due to the mobiles served by a station in question, this summed load being compared with a threshold related to the threshold budget.

11. Control method for a wireless communications network comprising the steps of:
a. calculating a load for each mobile from quantities related to attenuations measured between mobiles and base stations, and/or to the signal to interference and noise ratio threshold,
b. from the loads calculated at step a, evaluating a working condition, representing the feasibility of the service of mobiles by a station,
c. deciding on the treatment of new candidate mobiles from step b.

12. Method according to claim 11, characterised in that the working condition of step b relates to the summed load due to the mobiles served by a station in question.

13. Method according to claim 11, characterised in that step a comprises, for a mobile,
summing the inverses of the attenuations of the adjoining stations,
multiplying the result by an expression related to the signal to interference and noise signal ratio, and by the attenuation at the server station.

14. Method according to claim 11, characterised in that step b comprises storing a current value of the summed load and, during a new iteration of the method for a candidate mobile, step a comprises calculating the load of the candidate mobile, step b comprises updating the summed load and comparing the summed load with a threshold in order to determine whether or not the mobile is admitted at step c.

15. Method according to claim 11, characterised in that step a comprises first of all evaluating a prior uplink budget condition (UBC), compared with a threshold budget value (UBC), and rejecting the candidate mobile if this condition is not satisfied.

16. Method according to claim 15, characterised in that the prior condition of step a comprises, for a mobile, the calculation of its maximum power, divided by an expression related to the signal to interference and noise ratio, and by the attenuation at the server station.

17. Method according claim 15, characterised in that the working condition of step b comprises a threshold value established in correspondence with the said threshold budget value (UBC).

18. Method according to claim 11, characterised in that steps a to c comprise evaluating, for a given station, a non-congestion criterion, and in that step c comprises modifying the mobile rates in order to remain within the congestion criterion field.

19. Method according to claim 18, characterised in that step a comprises, for each mobile, calculating its signal to interference and noise ratio threshold, and then calculating an expression related to this signal to interference and noise ratio threshold, and calculating the load on each mobile with this expression, and in that step b comprises calculating the summed load due to the mobiles served by a station in question and comparing this summed load with a threshold.

20. Method according to claim 18, taken in combination with claim 15, characterised in that step a comprises, for each mobile, calculating its signal to interference and noise ratio threshold and then calculating an expression related to this signal to interference and noise ratio threshold, and then:
evaluating the prior uplink budget condition (UBC), with respect to a threshold budget value (UBC), the mobile concerned being rejected if this prior condition is not satisfied,
for the mobiles which are not rejected, calculating the loads from the calculated expressions, the summed load due to the mobiles served by a station in question being calculated and compared with a threshold related to the threshold budget at step b.
